(19) United States
(12) Patent Application Publication
(10) Pub. No.: US 2012/0204471 A1
(43) Pub. Date: Aug. 16, 2012

(54) BAIT CLIP FOR JIG HEAD

(75) Inventors: Branden Roberts, South Padre Island, TX (US); Eleno Salinas, South Padre Island, TX (US)

(73) Assignee: LOGIC LURES, INC., South Padre Island, TX (US)

(21) Appl. No.: 13/396,097

(22) Filed: Feb. 14, 2012

Related U.S. Application Data
(60) Provisional application No. 61/443,469, filed on Feb. 16, 2011.

(51) Int. Cl. A01K 85/00

(52) U.S. Cl. 43/42.32; 43/42.39

(57) ABSTRACT

A bait clip may be used with a fishing lure. The fishing lure has a weighted body. The weighted body includes a groove which extends at least partly around the weighted body. The fishing lure is adapted to be inserted into bait. The bait clip includes a clip portion and a face portion. The clip portion has a first leg and a second leg extending from one end of the clip portion. The face portion is rigidly fixed to the one end of the clip portion. The face portion has a surface which outwardly presents an image. The face portion defines a plane. The plane is generally perpendicular to the first and second legs. The clip portion is configured to be inserted around or through the bait pinning at least a portion of the bait within the groove.

### RELATED APPLICATIONS

The present application claims priority to U.S. Provisional Patent Application Ser. No. 61/443,469, filed Feb. 16, 2011, which is hereby incorporated by reference.

### FIELD OF THE INVENTION

The present invention relates generally to fishing lure, and more particularly, to a bait clip for a fishing lure jig.

### BACKGROUND OF THE INVENTION

Fishing remains one of the most popular sports. When fishing for game fish, one of the best baits available is usually live bait. The motion provided by live bait appears to be more attractive to the fish than artificial lures or bait. However, live bait has its own inconveniences, including availability and cost, as well as requiring a means to keep the live bait fresh during transport and fishing.

One type of a fishing lure is known as a jig or jig head. Typically, the jig head includes a lead sinker with a hook molded into it. The jig head is typically covered by a bait element. The bait element may be comprised of a soft body to attract fish. The jig head may include an eyelet to which a fishing line is fixed.

The weight may include a groove or one or more slots. The jig head may be inserted within the bait (live or fake). If the bait is placed over the grooves or slots, then the grooves or slots assist in keeping the bait affixed to the jig head.

One type of a fishing lure is known as a jig head. Generally, the jig head includes a weight and an attachment for a hook. The hook may be rigidly fixed to the weight or may be allowed pivot with respect to any eye hook, which is rigidly fixed to the weight. The weight may include a groove or one or more slots. The jig head may be inserted within the bait (live or fake). If the bait is placed over the grooves or slots, then the grooves or slots assist in keeping the bait affixed to the jig head. These types of jig head fishing lures do not provide very life-like movement of the lure when in use. Another issue with the typical jig heads of this type is that the bait may become unattached therefrom. Additionally, the jig head and bait may not appear extremely life-like.

The present invention is aimed at the problem identified above.

### SUMMARY OF THE INVENTION

In one aspect of the present invention, a bait clip designed to be used with a fishing lure is provided. The fishing lure has a weighted body. The weighted body includes a groove which extends at least partly around the weighted body. The fishing lure is adapted to be inserted into bait. The bait clip includes a clip portion and a face portion. The clip portion has a first leg and a second leg extending from one end of the clip portion. The face portion is rigidly fixed to the one end of the clip portion. The face portion has a surface which outwardly presents an image. The face portion defines a plane. The plane is generally perpendicular to the first and second legs. The clip portion is configured to be inserted around or through the bait pinning at least a portion of the bait within the groove.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is an illustration of an exemplary fishing lure jig head;

FIG. 2 is an illustration of a bait clip, according to an embodiment of the present invention; and,

FIG. 3 is an illustration of the bait clip of FIG. 2 in use with the exemplary fishing lure jig head of FIG. 1.

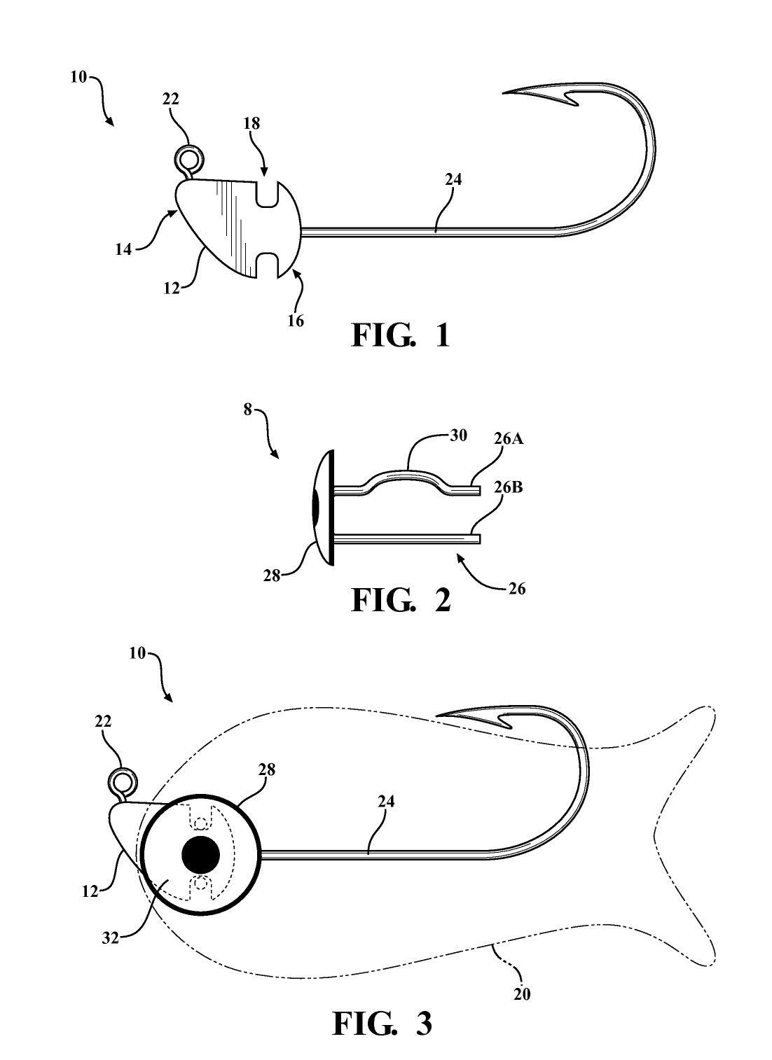

### DETAILED DESCRIPTION OF INVENTION

With reference to the drawings, and in operation, the present invention provides a bait clip 8 for use with a fishing lure or jig head 10, which may be used for sports fishing.

The fishing lure 10 includes a weighted body 12. The weighted body 12 has a front end 14 and a back end 16.

The weighted body 12 may include a groove 18, which may extend all or part way around thereof. The groove 18 may include one or more slots, as shown. As shown in FIG. 3, the jig head 10, in use, may be inserted within bait 20, which may be live or fake. The groove 18 assists in keeping the bait 20 affixed to the jig head 10.

An eye hook 22 is affixed to the front end 14 of the weighted body 12. In the illustrated embodiment, a fishing hook 24 is affixed to the back end 16 of the weighted body 12.

One such fishing lure is disclosed in commonly owned US Patent Application Serial Number (N/A), filed (N/A), Attorney Docket 068,414.00007, which is hereby incorporated by reference.

With specific reference to FIGS. 2-3, the bait clip 8 includes a clip portion 26 and a face portion 28.

The clip portion 26 may be removably coupled to the weighted body 12. In the illustrated embodiment, the clip portion 26 includes a first leg 26A and a second leg 26B. The first and second legs 26A, 26B extending from one of the clip portion 26. The first leg 26A may include an arc portion 30. In use, the clip portion 26 may be inserted around the bait 20 or through the bait 20, pinning at least a portion of the bait 20 within the groove or slot(s) 18. Use of the clip portion 22 helps maintain the bait 20 in position relative to the lure 10. In one embodiment, the arc portion 30 is shaped to match the shape of the groove 18 to facilitate the holding of the bait to the lure 10.

The face portion 28 is rigidly fixed to the clip portion 22. In the illustrated embodiment, the face portion 28 defines a plane which is generally perpendicular to the legs 26A, 26B. The face portion 28 has a surface 32, as shown in FIG. 3 which present in image or view, such as an eyeball, to the target, i.e., fish, to provide a more lifelike appearance thereto.

### INDUSTRIAL APPLICABILITY

With reference to the drawings and in operation, the present invention, provide a bat clip 22 for use with a fishing lure fishing lure 10 which exhibits, in use, a more life-like appearance. The fishing lure 10 may be fixed to a fishing line via a freely rotating eye hook (first eye hook 22). This allows the fishing lure 10 to move more naturally in the water. Additionally, a fishing hook 24 is fixed relative to the body of the fishing lure 10. This allows the fishing hook also to rotate more freely relative to the body of the lure. Although the weighted body 12 is shown in the drawings with a particular shape, any suitable shape may be used. For example, the weighted body 12 may be round, conical or may have a fanciful shape, such as a fish head.

The clip portion 26 is comprised from a metal, such as aluminum or stainless steel, but other metals or other suitable materials, such as plastic, may also be used. The face portion 28 is generally made of a plastic material or the like, but other materials may also be used. The face portion 28 may be affixed to the clip portion 26 by any suitable means, including an adhesive, welding, or a clip (not shown). Alternatively, the clip portion 26 and the face portion 28 may be unitarily formed from a common material such as a plastic. The image or view on the surface 32 may be painted or otherwise applied to the surface and may be formed therein (during the manufacturing thereof).

The weighted body 12 may be made, at least partly, out of rubber, or a rubber-like material, or silicon. The weighted body 12 may also be provided in different colors, via a paint or other coated applied thereto, or by any other suitable means may consist of many different shapes and colors along with different features.

While the invention has been described in detail with particular reference to the illustrated embodiment, many modifications and variations of the present invention are possible in light of the above teachings.

What is claimed is:

1. A bait clip for use with a fishing lure, the fishing lure having a weighted body, the weighted body including a groove which extends at least partly around the weighted body, the fishing lure being adapted to be inserted into bait, comprising:
a clip portion having a first leg and a second leg extending from one end of the clip portion; and,
a face portion rigidly fixed to the one end of the clip portion, the face portion having a surface which outwardly presents an image, the face portion defining a plane, the plane being generally perpendicular to the first and second legs, the clip portion being configured to be inserted around or through the bait pinning at least a portion of the bait within the groove.

2. A bait clip, as set forth in claim 1, the first leg including an arc portion configured to match the groove of the weighted body.

3. A bait clip, as set forth in claim 1, wherein the image is of an eye.

4. A bait clip, as set forth in claim 1, wherein the clip portion is composed from a metal.

5. A bait clip, as set forth in claim 4, wherein the metal is of aluminum and stainless steel.

6. A bait clip, as set forth in claim 1, wherein the clip portion is composed from a plastic.

7. A bait clip, as set forth in claim 1, the face portion being affixed to the clip portion one of an adhesive, welding, or a clip.

8. A bait clip, as set forth in claim 1, the face portion and the clip portion being unitarily formed.
